(19) United States
(12) Patent Application Publication
(10) Pub. No.: US 2021/0216985 A1
(43) Pub. Date: Jul. 15, 2021

(54) SYSTEM AND METHODS FOR RESOURCE ALLOCATION BASED ON SERVICE STREAMING

(71) Applicant: BANK OF AMERICA CORPORATION, Charlotte, NC (US)

(72) Inventor: Yash Sharma, New Delhi (IN)

(73) Assignee: BANK OF AMERICA CORPORATION, Charlotte, NC (US)

(21) Appl. No.: 16/739,653

(22) Filed: Jan. 10, 2020

(51) Int. Cl. G06Q 20/14; H04N 21/2543; G06Q 20/22; G06Q 20/08

(52) U.S. Cl. CPC G06Q 20/145; G06Q 20/0855; G06Q 20/29; H04N 21/2543

(57) ABSTRACT

Embodiments of the invention are directed to a system, method, or computer program product for resource allocation based on service streaming. A platform is provided for managing resource allocation vectors for a number of services that employ the resource allocation platform to offer streaming of resource allocation for services. The platform may track the amount of time that the user accesses services and stream resources from a user account in order to transact resources for partial use of a service based on the amount of time the service or certain content is used or accessed.

### FIELD OF THE INVENTION

The present disclosure embraces a system and methods for executing continuous resource transfers based on service streaming.

### BACKGROUND

Current solutions for allocating resources for services are limited by resource processing systems designed to initiate and execute intermittent and final resource transfers based on a total resource cost per service. As such, a need exists for enhanced systems for resource allocation based on service streaming which reflects a partial resource amount for partial use of services and products.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Payment and transactions executed by conventional systems and methods are typically completed based on discrete payment amounts for total cost of services or products. As such, a user wishing to use or access a particular service may have no choice but to pay for the total cost of a service for which they do not intend to use completely, or may not be able to use completely. As such, there is a need for transaction systems and methods that allow for continuous payment streaming that more naturally aligns with the streaming nature of many of today's services. For instance, a user may wish to begin streaming a movie using a content streaming service. In this instance, the user may prefer to only pay for the partial amount of the media accessed, as opposed to the entire cost of the full media, such as a movie or television show. While conventional content streaming services allow for the streaming of media and content, the same approach is not currently supported by resource transaction systems, in part due to the more complex nature of resource transactions (e.g., authorization, amount verification, accounting data management, and the like associated with resource transactions) versus media and digital content transmissions. Additionally, streaming of resources in conjunction with service streaming requires a metric by which resources can be measured and compared against amount of services or content (e.g., time, data size, and the like).

In response to the need for a resource transaction processing system which supports and complements conventional content streaming services and other services that may call for variable time-dependent or use-dependent pricing. The invention provides a secure platform for resource allocation based on service cost per time period or usage metric and automates the secure transfer of resources from a user resource account to a service provider or vendor. The secure platform of the invention allows a vendor service provider to provide relevant information about a service in the form of a resource allocation vector which the platform may use to measure cost of services over a specified timeframe. A user who wishes to use services offered by the vendor service provider may initiate a streaming resource allocation from one or more user resource accounts managed by the secure platform for resource allocation using a user device. Once the streaming resource allocation has been initiated, resources are continually streamed or transferred from the one or more user resource accounts to the vendor service provider's account at a rate determined by the resource allocation vector. A total resource amount at the conclusion of the service is determined by the amount of time in which the user is using the services as multiplied by the resource allocation vector. As such, the user is only responsible for an amount of resources relative to their time-measured use of the services, as opposed to the maximum amount for a complete, total, or otherwise maximized use of the service or product. While the invention may be employed in some embodiments related to digital content streaming, it is understood that the invention may also be applied for use in other embodiments, such as allocating resources for a specific length of service for a hotel stay, car rental, device rental, property lease, and the like. Other various industries where the invention may be applicable include, but are not limited to, any industry involving time-measured services, such as various contracting tasks, cleaning services, daycare, pet care, parking, security patrol services, and the like.

For instance, in some embodiments, the user may choose to stream a movie from a vendor service system, such as a content streaming service, and may initiate a streaming resource transaction. The resource streaming transaction and associated resource allocation vector provides a method of resource payment based on an amount of time (e.g., minutes, seconds, milliseconds, and the like) of a particular movie the user watches. The vendor service system may set a resource allocation vector (e.g. dollars per seconds, cents per milliseconds, and the like) to measure the cost of the partial use of the service, which in this particular embodiment would be a partial viewing of a movie or other media content provided by the vendor service system. The resource streaming may be configured to be initiated via a resource call to the secure platform, wherein resource streaming may be initiated automatically in response to the call. In other embodiments, a notification may be sent to a user that includes resource streaming terms, estimated total resource cost and the like, that allows the user to accept the resource call and authorize resource streaming from the user's resource account for a particular purpose.

In some embodiments, the invention generally may include receiving a request to configure a resource streaming service from a vendor service system; generating a resource streaming service configuration for the resource streaming service; transmitting a request for streaming service configuration details to a vendor service system; receiving streaming the service configuration details from the vendor service system and populate the resource streaming service configuration with the received streaming service configuration details to create a configured streaming service; requesting authorization from a user for resource streaming, wherein resource streaming comprises continuously streaming resources from a resource account belonging to the user to a vendor account to pay for the configured streaming service; and initiating a resource stream from the resource account belonging to the user to the vendor account, wherein resources are streamed continuously from the user resource account to the vendor account for a period of time that the streaming service is ongoing.

In some embodiments, the streaming service configuration details further comprise a resource allocation vector for the streaming service, wherein the resource allocation vector is a rate metric equal to a resource amount per unit of time.

In some embodiments, the streaming service configuration details further comprise a streaming service identification, a resource type, a time metric, and a maximum resource amount or maximum time for the streaming service.

In some embodiments, the invention further comprises receiving a resource call from the vendor service system before initiating the resource stream, wherein the resource call comprises user authentication credentials for accessing the user resource account.

In some embodiments, the invention further comprises verifying the user resource account for the configured streaming service prior to streaming resources by comparing available resource balance of the resource account belonging to the user to a maximum resource amount for the configured streaming service.

In still further embodiments, the invention may be further configured to activate a resource streaming buffer, wherein the resource streaming buffer comprises a time delay of streaming resources from the resource account belonging to the user to the vendor account based on a predetermined multiple of a resource allocation vector or a determined latency in communication between the resource allocation platform and vender service system.

In other embodiments, the invention may further be configured to transmit a projected maximum resource cost to the user via a user device prior to resource streaming, wherein the projected maximum resource cost comprises a resource allocation vector multiplied by a maximum amount of time that the streaming service is ongoing; transmit an authorization request to the user via the user device to verify acceptance of the projected maximum resource cost; and authorize initiation of resource streaming in response to receiving authorization from the user for the projected maximum resource cost.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an integrated secure resource allocation platform system environment 100, in accordance with one embodiment of the present invention;

FIG. 2 provides a high level process flow diagram 200 of a resource allocation vector, in accordance with one embodiment of the present invention.

FIG. 3 provides a high level process flow diagram 300 for transmitting a resource call for initiation of resource streaming, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any customer of an entity or individual that interacts with an entity. The user may interact with the entity as a customer, such as a customer purchasing a product or service. Furthermore, as used herein the term “user device” or “mobile device” may refer to mobile phones, personal computing devices, tablet computers, wearable devices, and/or any portable electronic device capable of receiving and/or storing data therein.

As used herein, “resource allocation platform” refers to the primary platform of the invention that is responsible for the device, processes, and methods of supporting and providing secure resource streaming from one or more user accounts to other accounts, such as vendor accounts. In some embodiments, the resource allocation platform may be managed by the same entity that manages one or more user resource accounts, or may be managed by a separate entity in other embodiments. The resource allocation platform is designed to operatively communicate with one or more entities, users, and systems over a network via one or more user devices or third party devices.

As used herein, an “third party system” may be a system managed by an entity other than the entity that manages the resource allocation platform. In other embodiments, the third party system may be a user device belonging to a user who is not associated with the resource allocation platform or vendor service systems, but has been granted access to a web portal, application, or other resource provide data or interface with the resource allocation platform or vender service systems. In some embodiments, an authorized third party device may refer to a device that has been previously identified as used by an authorized user for accessing the resource allocation platform resources.

As used herein, a “vendor service system” may be a system managed by an entity other than the entity that managed the resource allocation platform, and provides content or services that may be transacted for using resource streaming services provided by the resource allocation platform. Examples of a vendor service system may be any vendor that offers services or products that can be measured in cost based on a time-related metric. For instance, streaming media content for a specific period of time, accessing software or applications for a period of time, performing services or labor for a period of time, renting property or goods for a period of time, and the like.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

As used herein, the term “resource” may refer to physical currency, electronic data, or an exchangeable currency having a value (e.g., funds) or the like. A computing resource may refer to elements of one or more computing devices (e.g., processor, memory, communication device, and the like) networks, or the like available to be used in the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison). As used herein, a “resource vehicle” may refer to any medium for resource conveyance from one resource location to another.

As used herein, an “interaction” or “connection” may refer to any communication between one or more users or systems within the system environment described herein. For example, an interaction may refer to a transfer or exchange of user information (e.g., data, information, passwords, PIN codes, and the like) between systems, devices, and/or application; an accessing of stored data by one or more devices; a transmission of a requested task; a sharing or leveraging of resources (e.g., computing resources) between device; or the like. An interaction may include user interactions with a user interface (e.g., clicking, swiping, text or data entry, and the like), authentication actions (e.g., signing-in, username and password entry, PIN code, and the like), account actions (e.g., account access, and the like) and the like. In a specific embodiment, an “interaction” may refer to a resource transfer executed between one or more users and/or entities (e.g., a transaction).

As used herein, the term “entity” may be used to include any business or vendor system that the platform may interact with to complete a secure resource streaming or content streaming related activity. The terms “financial institution” and “financial entity” may be used to include any organization that processes financial transactions including, but not limited to, banks, credit unions, savings and loan associations, investment companies, stock brokerages, insurance companies, and the like. In other embodiments, an entity may be a business, organization, a government organization or the like that is not a financial institution. In a specific embodiment, an entity is a resource providing entity such as a financial institution that provides a resource vehicle and/or service (e.g., finance associated account) to a user. The resource vehicle and/or location may include supplementary resources.

As used herein, “authentication information” may refer to any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to at least partially authenticate the identity of the user (e.g., determine that the authentication information is associated with the account or particular user device) and determine that the user has authority to access a resource account, service, or system. In some embodiments, the system may be owned or operated by an entity. In such embodiments, the entity may employ additional computer systems, such as authentication servers, to validate and certify resources inputted by the plurality of users within the system.

As used herein, “web portal” may refer to a secure web site or web-accessible interface provided by the resource allocation platform to users, authorized third parties, and vendor service systems. In some embodiments, the web portal may be accessed via a provided user application on the user device or may be a secure web page accessible via a browser on a user device. In some embodiments, the web portal may used to display information from the application of the resource allocation platform, such as PIN codes, user resource account authorization information (e.g., username, password, account number, security questions, and the like). In specific embodiments, the web portal may be accessible only to users which have been granted access by the resource allocation platform or the vender service system, provided account information to the resource allocation platform, or set up an account with the resource allocation platform during an on-boarding process, and these specific users may be referred to as “on-boarded users.” In some embodiments, accessing the web portal or user application may require further authentication steps such as three-step authentication (e.g., via use of an authentication application, responding to an email link, and the like) biometric authentication (e.g., leveraging capability of the user device itself via biometric readers and processing), and the like

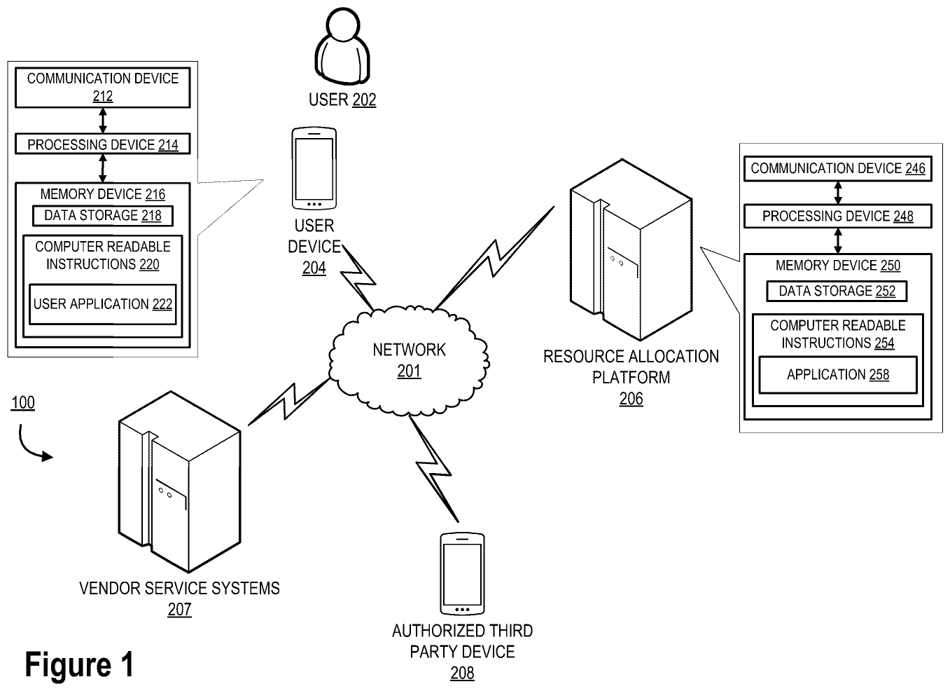

FIG. 1 provides an integrated secure resource allocation platform system environment 100, in accordance with one embodiment of the present invention. FIG. 1 provides the system environment 100 for which the distributive network system with specialized data feeds associated with an interconnected resource distribution and retention network. FIG. 1 provides a unique system that includes specialized servers and system communicably linked across a distributive network of nodes required to perform the functions described herein.

As illustrated in FIG. 1, the third party system 208 is operatively coupled, via a network 201 to the user device 204, vendor service systems 207, and to the resource allocation platform 206. In this way, the third party system 208 can send information to and receive information from the user device 204, vendor service systems 207, and the resource allocation platform 206. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), public switched telephone network (PSTN), or any other type of network or combination of networks. The network 201 may provide for wireline, wireless, or a combination wireline and wireless communication between devices on the network 201.

In some embodiments, the user 202 is an individual or entity that has one or more user devices 204. The user 202 may be a customer of an entity. The user 202 may wish to complete a transaction with the entity. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the resource allocation platform 206, the third party system 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the resource allocation platform 206.

As further illustrated in FIG. 1, the resource allocation platform 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the third party system 208, the vendor service systems 207, and the user device 204. As such, the communication device 246 generally comprises a modem, server, or other device for communicating with other devices on the network 201.

As further illustrated in FIG. 1, the resource allocation platform 206 comprises computer-readable instructions 254 stored in the memory device 250, which in one embodiment includes the computer-readable instructions 254 of an application 258. In some embodiments, the memory device 250 includes data storage 252 for storing data related to the system environment 100, but not limited to data created and/or used by the application 258.

In one embodiment of the resource allocation platform 206 the memory device 250 stores an application 258. In one embodiment of the invention, the application 258 may associate with applications having computer-executable program code. Furthermore, the resource allocation platform 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more third party system 208, vendor service systems 207, and/or user device 204.

As illustrated in FIG. 1, the vendor service systems 207 is connected to the third party system 208, user device 204, and resource allocation platform 206. The vendor service systems 207 has the same or similar components as described above with respect to the user device 204 and the resource allocation platform 206. While only one vendor service systems 207 is illustrated in FIG. 1, it is understood that multiple vendor service systems 207 may make up the system environment 100. The vendor service systems 207 may be associated with one or more financial institutions, entities, or the like and function as a point-of-sale device or point-of-transaction device for the user to interact with in order to complete a transaction with a merchant.

In some embodiments, the vendor service systems 207 is or includes an interactive computer terminal that is configured to initiate, perform, complete, and/or facilitate one or more transactions. The vendor service systems 207 could be or include any device that a user may use to perform a transaction with the merchant or an entity, such as, but not limited to a loyalty device such as a rewards card, loyalty card or other loyalty device, a magnetic-based payment device (e.g., a credit card, debit card, and the like), a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, cellular phone, personal digital assistant (PDA) device, MP3 device, personal GPS device, and the like), a gaming console or smart hub (e.g., a console, content streaming device, and the like), a cable box or digital video recorder (DVR), a merchant terminal, a self-service machine (e.g., vending machine, self-checkout machine, and the like), a public and/or business kiosk (e.g., an Internet kiosk, ticketing kiosk, bill pay kiosk, and the like), and/or various combinations of the foregoing.

In some embodiments, the vendor service systems 207 is operated in a public place (e.g., on a street corner, at the doorstep of a private residence, in an open market, at a public rest stop, and the like). In other embodiments, the vendor service systems 207 is additionally or alternatively operated in a place of business (e.g., in a retail store, post office, banking center, grocery store, factory floor, and the like), or in a user's home (e.g., a device connected to the user's television, home network, and the like). In accordance with some embodiments, the vendor service systems 207 is not owned by the user of the resource acceptance device. Rather, in some embodiments, the vendor service systems 207 is owned by a mobile business operator or a point-of-transaction operator (e.g., merchant, vendor, salesperson, and the like). In yet other embodiments, the vendor service systems 207 is owned by the financial institution offering the resource acceptance device providing functionality in accordance with embodiments of the invention described herein. In other embodiments, the vendor service systems 207 may be accessed via the user device 204 remotely (e.g., the user device 204 connects to vendor service systems 207 to stream content at the user's location, and the like).

As illustrated in FIG. 1, the third party system 208 is connected to the vendor service systems 207, user device 204, and resource allocation platform 206. In some embodiments, the third party system 208 may be associated with the vendor service systems 207. The third party system 208 has the same or similar components as described above with respect to the user device 204 and the resource allocation platform 206. While only one third party system 208 is illustrated in FIG. 1, it is understood that multiple third party system 208 may make up the system environment 100.

It is understood that the servers, systems, and devices described herein illustrate one embodiment of the invention. It is further understood that one or more of the servers, systems, and devices can be combined in other embodiments and still function in the same or similar way as the embodiments described herein. The third party system 208 may generally include a processing device communicably coupled to devices as a memory device, output devices, input devices, a network interface, a power source, one or more chips, and the like. The third party system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the third party system 208 described herein.

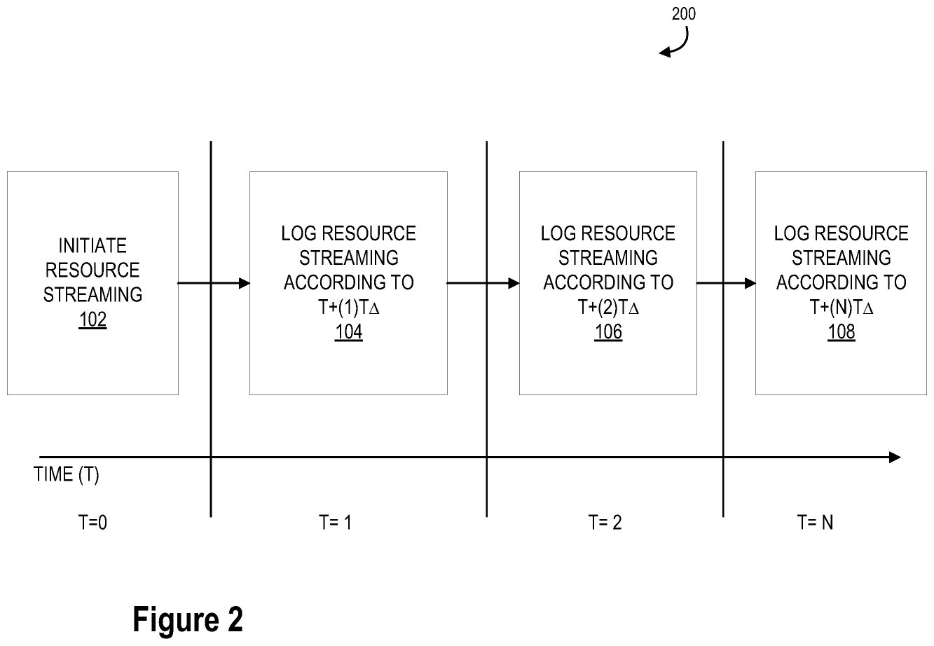

FIG. 2 provides a high level process flow diagram 200 of a resource allocation vector, in accordance with one embodiment of the present invention. As shown in FIG. 2, the process flow begins at initiating resource streaming, as shown in block 102. FIG. 2 depicts a hypothetical timeline in which the resource streaming will occur according to a resource allocation vector, TΔ. The resource allocation vector TΔ corresponds to a set rate at which resource will be allocated from a user resource account to a vendor resource account via the resource allocation platform 206 (e.g., “resource amount” over “time increment”). For example, the vendor may set a resource allocation vector of 0.01 dollars/second, wherein TΔ=(0.01/sec). As shown, this can be visualized via number of successive timeframes in which resource streaming is continually logged by tracking TΔ over a time period, T, from 0 to N, where N is equal to the total number of seconds in the time period. As shown, the process continues at block 104 wherein the platform logs resource streaming according to T+(1)TΔ, then moves to block 106, wherein the platform logs streaming according to T+(2)TΔ, and finally block 108 which indicates steaming logged at T+(N)TΔ. At the conclusion of the streaming process, the platform may access the information in block 108 to determine the maximum number of time (N) at which the resource allocation vector has been activated for a particular service accessed by the user, and the platform may deduct an exact amount from the user's resource account to send to the vendor resource account.

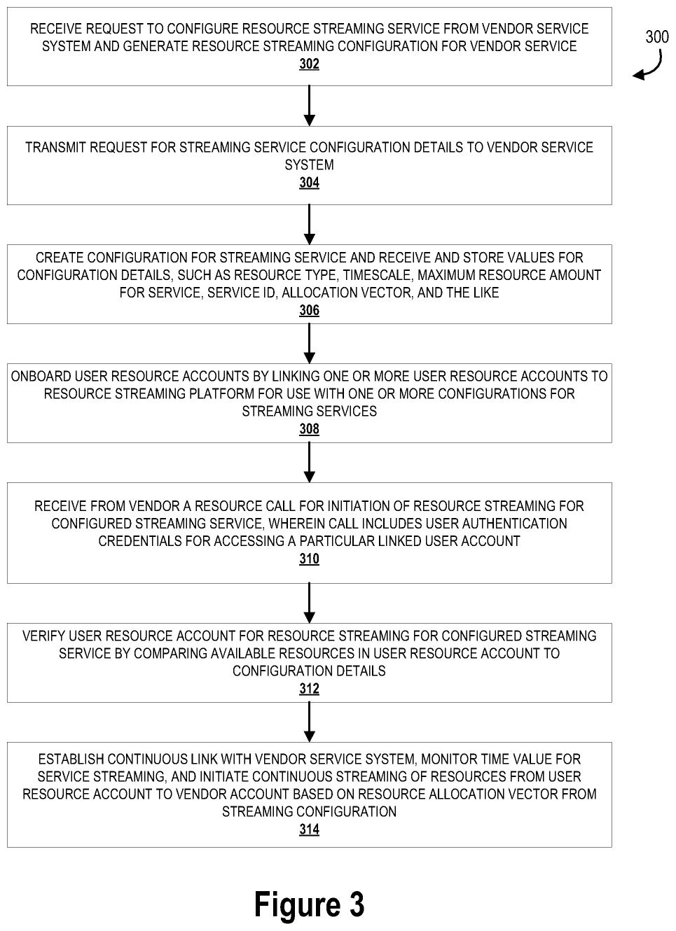

FIG. 3 provides a high level process flow diagram 300 for transmitting a resource call for initiation of resource streaming, in accordance with one embodiment of the present invention. As shown in FIG. 3, the process begins at block 302 wherein the resource allocation platform 206 receives a request from the vendor service system to configure a resource streaming service from vendor service system 207 and generate resource streaming configuration for a vendor service. In this way, the vendor service system 207 may communicate details regarding a service for which the vendor would like to configure resource streaming details, allowing payment to be received for the service via resource streaming from a user resource account. In some embodiments, the user resource account may be managed by the same entity that manages the resource allocation platform, while in other embodiments the resource allocation platform 206 simply stores information regarding one or more user resource accounts, or may be granted access to details of user resource accounts provided by one or more third party systems 208.

Next, as shown at block 304, the resource allocation platform 206 transmits a request for streaming service configuration details to vendor service system 207. The resource allocation platform 206 then creates a configuration for the streaming service where it may store details about the streaming service that it receives, such as acceptable resource types (e.g., US dollars, Canadian dollars, Chinese yuan, various cryptocurrencies, and the like), timescale for the service, maximum resource amount for service, service name, resource allocation vector, set timeline for streaming to be active, authorized user list, and the like, as shown in block 306. In this way, the resource allocation platform 206 may maintain a unique configuration for storing details about each streaming service that it supports, and may organize the streaming services based on one or more of the configuration details for inventory, audit, quality control, and security purposes.

Next, the resource allocation platform onboards user resource accounts in order to support payment for resource streaming services. In some embodiments, this may be done separately from the process of interfacing with the vendor service systems 207, wherein user resource accounts are linked to the resource allocation platform 206 independently of the vendor's input. In other embodiments, it is understood that user resource account details may be received from the vendor service system 207, or alternatively may be received from one or more third party systems 208. In any case, the resource allocation platform 206 onboards user resource accounts by linking one or more user resource accounts to resource streaming platform for use with one or more configurations for streaming services, as shown in block 308. For instance, the resource allocation platform may receive details regarding one or more user resource accounts from an entity system that manages the resource allocation platform 206, such as user identification, user password, verification of user opt-in for resource streaming, user resource account number, user resource account routing number, user resource account balance, and the like.

In some embodiments, the resource allocation platform 206 may transmit a request for user resource account onboarding directly to one or more users via the user device 204. In these embodiments, the resource allocation platform may receive onboarding details directly from the user in order to authorize one or more resource accounts owned by the user for use as resource streaming accounts. In other embodiments, the resource allocation platform 206 or vendor service system 207 may transmit a notification to the user via the user device displaying a cost projection summary of a particular vendor streaming service that has been configured on the resource allocation platform 206. For instance, if the user selects a movie for streaming from the vendor service system 207, the user may be directed to login to their resource streaming account at the resource allocation platform 206, wherein the resource allocation platform 206 may receive authentication details for the user and then transmit details for the particular vender streaming service that has been configured for the user's selected content. The cost projection summary may include a disclaimer that resources will be streamed in real time from the user's resource account up to a maximum amount of “x,” wherein “x” is equal to the resource allocation vector multiplied by T=max for the maximum amount of time the service may stream. For instance, a 60 minute movie with a resource allocation vector of 10 cents per minute may have a maximum amount of 6 dollars if the entire movie is streamed by the user.

Once the resource allocation platform 206 has configured one or more vendor services for resource streaming and onboarded one or more user resource accounts for resource streaming, the resource allocation platform 206 may activate the vendor service for resource streaming. The platform may then receive, from the vendor service system 207, a resource call for initiation of resource streaming for configured vendor streaming service, as shown in block 310. In some embodiments, the call includes user authentication credentials for accessing a particular linked user resource account. In other embodiments, the platform may require further user authentication and verification before resource streaming may be authorized to begin, as may be provided from the user via the user device.

Next, the platform may verify the user resource account for resource streaming for the configured vendor streaming service identified in the resource call by comparing available resources in the user resource account balance to configuration details in order to determine if the user resource account possesses the available funds to complete the maximum amount of the vendor streaming service as noted in the configuration details, or as calculated by the maximum streaming time for the service multiplied by the resource allocation vector associated with the vendor streaming service, as shown in block 312. After verification of available funds, the platform may establish a continuous link with vendor service system, or establish a periodic clocked transmission to ping the vendor service system 207 in order to monitor a time value for service streaming, or track the amount of time for which the service is activated over a given time period (e.g., track how many minutes of a movie or television show are streamed, track how long a user is checked into a specific hotel room using booking information, check out information, location data, or a combination thereof, and the like), and initiate continuous streaming of resources from user resource account to vendor account based on resource allocation vector from streaming configuration, as shown in block 314. At the conclusion of the vendor streaming service, the platform may receive a stop notification from the vendor service system 207, and will conclude the streaming of resources from the user resource account to the vendor account.

In some embodiments, the streaming of resources from the user resource account may be subject to a resource streaming buffer based on the latency of connection between the resource allocation platform and the vender service system 207, or based on some pre-determined multiple of the resource allocation vector for a particular vendor streaming service. For instance, the resource allocation platform 206 may recognize a latency of data transfer between the resource allocation platform 206 and the vendor service systems 207 is a value of 4 seconds, wherein it takes 4 seconds for updated streaming data to be received from the vendor service systems 207 as compared to the real time use of the vendor streaming service. The resource streaming buffer may be a hold or delay of streamed resourced from the user resource account to the vendor account. In some embodiments, the resource streaming buffer may include deducting the resources from the user resource account, holding them at the resource allocation platform 206 for a given period of time either based on latency or configured amount of time, after which the resource allocation platform 206 may then transmit the resources to the vendor account after allotted amount of time for the resource streaming buffer. In other embodiments, the resource allocation platform 206 may employ a pre-determined resource streaming buffer for all vendor streaming services, as can be programmed by an administrative user, such that streaming of user resources are delayed at a certain multiple of the resource allocation vector for each vendor streaming service. For instance, if the pre-determined resource streaming buffer is programmed to be a multiple of 4, and a particular vendor streaming service has an allocation vector of 4 dollars per minute, the resource allocation platform may withhold 16 dollars at the resource allocation platform at all times during an active streaming period in order to avoid transmitting more resources than necessary due to latency of streaming information received from the vendor service system. In other embodiments, the resource allocation platform may alternatively delay deduction from the user resource account based on the resource streaming buffer as opposed to deducting the resources from the user resource account and holding the resources at the resource allocation platform 206.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for resource allocation platform for resource allocation based on service streaming, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
receive a request to configure a resource streaming service from a vendor service system;
generate a resource streaming service configuration for the resource streaming service;
transmit a request for streaming service configuration details to a vendor service system;
receive streaming the service configuration details from the vendor service system and populate the resource streaming service configuration with the received streaming service configuration details to create a configured streaming service;
request authorization from a user for resource streaming, wherein resource streaming comprises continuously streaming resources from a resource account belonging to the user to a vendor account to pay for the configured streaming service; and
initiate a resource stream from the resource account belonging to the user to the vendor account, wherein resources are streamed continuously from the resource account belonging to the user to the vendor account for a period of time that the streaming service is ongoing.

2. The system of claim 1, wherein the streaming service configuration details further comprise a resource allocation vector for the resource streaming service, wherein the resource allocation vector is a rate metric equal to a resource amount per unit of time.

3. The system of claim 1, wherein the streaming service configuration details further comprise a streaming service identification, a resource type, a time metric, and a maximum resource amount or maximum time for the resource streaming service.

4. The system of claim 1, further comprising receiving a resource call from the vendor service system before initiating the resource stream, wherein the resource call comprises user authentication credentials for accessing the user resource account.

5. The system of claim 1, further comprising verifying the user resource account for the configured streaming service prior to streaming resources by comparing available resource balance of the resource account belonging to the user to a maximum resource amount for the configured streaming service.

6. The system of claim 1, wherein the system is further configured to activate a resource streaming buffer, wherein the resource streaming buffer comprises a time delay of streaming resources from the resource account belonging to the user to the vendor account based on a predetermined multiple of a resource allocation vector or a determined latency in communication between the resource allocation platform and vender service system.

7. The system of claim 1, further configured to transmit a projected maximum resource cost to the user via a user device prior to resource streaming, wherein the projected maximum resource cost comprises a resource allocation vector multiplied by a maximum amount of time that the resource streaming service is ongoing; and
transmit an authorization request to the user via the user device to verify acceptance of the projected maximum resource cost; and
authorize initiation of resource streaming in response to receiving authorization from the user for the projected maximum resource cost.

8. A computer program product for resource allocation platform for resource allocation based on service streaming, the computer program product comprising a non-transitory computer-readable storage medium having computer-executable instructions to:
receive a request to configure a resource streaming service from a vendor service system;
generate a resource streaming service configuration for the resource streaming service;
transmit a request for streaming service configuration details to a vendor service system;
receive streaming the service configuration details from the vendor service system and populate the resource streaming service configuration with the received streaming service configuration details to create a configured streaming service;
request authorization from a user for resource streaming, wherein resource streaming comprises continuously streaming resources from a resource account belonging to the user to a vendor account to pay for the configured streaming service; and
initiate a resource stream from the resource account belonging to the user to the vendor account, wherein resources are streamed continuously from the resource account belonging to the user to the vendor account for a period of time that the streaming service is ongoing.

9. The computer program product of claim 8, wherein the streaming service configuration details further comprise a resource allocation vector for the resource streaming service, wherein the resource allocation vector is a rate metric equal to a resource amount per unit of time.

10. The computer program product of claim 8, wherein the streaming service configuration details further comprise a streaming service identification, a resource type, a time metric, and a maximum resource amount or maximum time for the resource streaming service.

11. The computer program product of claim 8, further comprising receiving a resource call from the vendor service system before initiating the resource stream, wherein the resource call comprises user authentication credentials for accessing the user resource account.

12. The computer program product of claim 8, further comprising verifying the user resource account for the configured streaming service prior to streaming resources by comparing available resource balance of the resource account belonging to the user to a maximum resource amount for the configured streaming service.

13. The computer program product of claim 8, wherein the system is further configured to activate a resource streaming buffer, wherein the resource streaming buffer comprises a time delay of streaming resources from the resource account belonging to the user to the vendor account based on a predetermined multiple of a resource allocation vector or a determined latency in communication between the resource allocation platform and vender service system.

14. The computer program product of claim 8, further configured to transmit a projected maximum resource cost to the user via a user device prior to resource streaming, wherein the projected maximum resource cost comprises a resource allocation vector multiplied by a maximum amount of time that the resource streaming service is ongoing;
transmit an authorization request to the user via the user device to verify acceptance of the projected maximum resource cost; and
authorize initiation of resource streaming in response to receiving authorization from the user for the projected maximum resource cost.

15. A computer implemented method for resource allocation platform for resource allocation based on service streaming, the computer implemented method comprising:
receiving a request to configure a resource streaming service from a vendor service system;
generating a resource streaming service configuration for the resource streaming service;
transmitting a request for streaming service configuration details to a vendor service system;
receiving streaming the service configuration details from the vendor service system and populate the resource streaming service configuration with the received streaming service configuration details to create a configured streaming service;
requesting authorization from a user for resource streaming, wherein resource streaming comprises continuously streaming resources from a resource account belonging to the user to a vendor account to pay for the configured streaming service; and
initiating a resource stream from the resource account belonging to the user to the vendor account, wherein resources are streamed continuously from the resource account belonging to the user to the vendor account for a period of time that the streaming service is ongoing.

16. The computer implemented method of claim 15, wherein the streaming service configuration details further comprise a resource allocation vector for the resource streaming service, wherein the resource allocation vector is a rate metric equal to a resource amount per unit of time.

17. The computer implemented method of claim 15, wherein the streaming service configuration details further comprise a streaming service identification, a resource type, a time metric, and a maximum resource amount or maximum time for the resource streaming service.

18. The computer implemented method of claim 15, further comprising receiving a resource call from the vendor service system before initiating the resource stream, wherein the resource call comprises user authentication credentials for accessing the user resource account.

19. The computer implemented method of claim 15, further comprising verifying the user resource account for the configured streaming service prior to streaming resources by comparing available resource balance of the resource account belonging to the user to a maximum resource amount for the configured streaming service.

20. The computer implemented method of claim 15, wherein the resource allocation platform is further configured to activate a resource streaming buffer, wherein the resource streaming buffer comprises a time delay of streaming resources from the resource account belonging to the user to the vendor account based on a predetermined multiple of a resource allocation vector or a determined latency in communication between the resource allocation platform and vender service system.
